(19) United States
(12) Patent Application Publication
(10) Pub. No.: US 2002/0058160 A1
(43) Pub. Date: May 16, 2002

(54) Perpendicular magnetic recording medium

(76) Inventors: Soichi Oikawa, Yokohama-shi (JP); Takashi Hikosaka, Tokyo (JP); Futoshi Nakamura, Yamato-shi (JP)

Correspondence Address: Pillsbury Winthrop LLP, Intellectual Property Group, 1600 Tysons Boulevard, McLean, VA, 22102, US

(21) Appl. No.: 09/808,427

(22) Filed: Mar. 15, 2001

(30) Foreign Application Priority Data
Sep. 21, 2000 (JP) 2000-287720

(51) Int. Cl. G11B 5/66

(52) U.S. Cl. 428/694 TS

(57) ABSTRACT

A perpendicular magnetic recording medium comprises a combination of an under layer of a laminate structure including at least two layers and a Co-based magnetic layer. The particular combination is selected from the group consisting of i) Fe-containing layer/Ru/magnetic layer, ii) Co-containing layer/Ru/magnetic layer, iii) Ru/Co-containing layer/magnetic layer, iv) Ti-containing layer/Ru/magnetic layer, and v) soft magnetic layer/V or Cr/magnetic layer. A multi-layered structure of magnetic layer/Ru/magnetic layer is used as the magnetic layer included in combinations i) to v) given above. The perpendicular magnetic recording medium of the particular construction permits improving the perpendicular orientation of the Co-based magnetic layer and exhibits a high coercive force and a high reproducing output.

### CROSS-REFERENCE TO RELATED APPLICATIONS

This application is based upon and claims the benefit of priority from the prior Japanese Patent Application No. 2000-287720, filed Sep. 21, 2000, the entire contents of which are incorporated herein by reference.

### BACKGROUND OF THE INVENTION

The present invention relates to a perpendicular magnetic recording medium, particularly, to a perpendicular magnetic recording medium comprising a ferromagnetic magnetic recording layer containing cobalt.

In a perpendicular magnetic recording system, information is recorded by magnetization in the direction perpendicular to the recording medium surface. Compared with the areal magnetic recording system, the perpendicular magnetic recording system is low in demagnetizing field within each bit in performing a high density recording and, thus, is adapted for the improvement in the areal recording density.

Also, the perpendicular magnetic recording medium, in which a soft magnetic layer is arranged between the substrate and the perpendicular magnetic recording layer, performs the function of a so-called “perpendicular double layered medium”. The soft magnetic layer acts as the flux path to assist the recording magnetic field in refluxing between the magnetic head and the recording medium so as to improve the recording-reproducing efficiency. A cobalt-based material such as a CoCr alloy, a CoPt alloy or CoCrPt alloy is used in the perpendicular magnetic recording layer. Cobalt has a hexagonal close-packed structure (hcp structure). When a thin film of Co is formed, the easy magnetization axis of cobalt tends to be oriented in a direction perpendicular to the film surface. Therefore, Co is adapted for use in the preparation of a perpendicular magnetic recording layer.

In order to improve the magnetic recording characteristics, it is necessary to improve the perpendicular magnetic anisotropy of the Co-based recording layer and to promote the fineness of the crystal grains in the Co-based recording layer, thereby improving the coercive force and magnetostatic characteristics such as a perpendicular squareness ratio. To this end, known is a method that a nonmagnetic under layer such as a Ti layer is formed between a CoCr-based recording layer and a nonmagnetic substrate. This method is effective for improving the perpendicular orientation of the perpendicular magnetic recording layer. As described above, in the case of arranging a soft magnetic layer, the perpendicular orientation of the Co-based magnetic recording layer is rendered poorer than in the case where the Co-based magnetic recording layer is formed in direct contact with the nonmagnetic substrate. It is possible to improve the perpendicular orientation of the magnetic recording layer by arranging an under layer such as a Ti layer between the soft magnetic layer and the magnetic recording layer in this case, too. However, for further improving the recording density, required is a nonmagnetic under layer that permit obtaining a higher orientation.

On the other hand, it was most popular in the past to use a material containing Co and Cr as main components for forming the perpendicular magnetic recording layer. It should be noted in this connection that Cr is segregated in the crystal grain boundary in the material containing Co and Cr as main components, making it possible to obtain a magnetic recording medium having a high coercive force and a high signal to noise ratio. However, it was impossible to obtain a sufficient perpendicular magnetic anisotropy by simply adding, for example, traces of Ta to the CoCr recording layer. On the other hand, a CoPt alloy recording layer exhibits a magnetic anisotropy larger than that exhibited by the elemental Co, though it is difficult to obtain a large coercive force and a high S/N ratio because Pt is not segregated in the grain boundary in the case of the CoPt alloy recording layer. Such being the situation, it has been clarified that, in the recording layer prepared by adding Pt to the CoCr alloy, it is possible to obtain magnetic recording characteristics more excellent than those of the CoCr recording layer. A CoPtO recording layer prepared by adding oxygen to a CoPt magnetic layer is proposed in, for example, Japanese Patent Disclosure (Kokai) No. 7-235034, which corresponds to U.S. Pat. No. 5,792,564, as a means for improving the magnetic recording characteristics of the magnetic recording layer. It is taught in the prior art that it is possible to prepare a magnetic recording medium exhibiting high perpendicular anisotropy and coercive force and satisfactory in the S/N ratio by forming a grain boundary layer rich in oxygen. A quite different method utilizing a multi-layered film consisting of a combination of Co and, for example, Pd has also been found. To be more specific, it has been found that a very high perpendicular anisotropy can be obtained by utilizing the interfacial magnetic anisotropy generated at the interface between Co and Pd. It has also been found that the S/N ratio can be improved to some extent by forming a segregation structure by, for example, an oxygen addition. However, since the matching of the lattice constant between Co and Pd or Pt is insufficient, the crystallinity of the multi-layered film was not sufficiently high.

As described above, various combinations between the Co-based alloy and the materials of the under layer have been found in respect of the perpendicular magnetic recording medium using a Co-based alloy magnetic recording layer. However, further improvements are required for obtaining a perpendicular magnetic recording medium capable of exhibiting a satisfactory perpendicular anisotropy and a good S/N ratio and also capable of realizing a higher coercive force and a higher reproducing output.

The crystal orientation and the crystal grain diameter of the magnetic recording layer are greatly dependent on the surface state of the substrate. Therefore, even where a nonmagnetic under layer is applied, it is necessary to control the surface state of the substrate for further improving the perpendicular orientation the recording layer. Where, for example, Ti is used for forming the under layer, it is taught in, for example, Japanese Patent Disclosure No. 6-58734 that it is possible to obtain a surface state of the under layer, which can be perpendicularly oriented easily, by further forming a nonmagnetic layer made of Si, Ge or Sn between the substrate and the Ti under layer. It is described in the prior art quoted above that it is effective to form the nonmagnetic under layer of the double-layered structure between a soft magnetic layer and a Co-based recording layer in a perpendicular double layered film. However, for further improving the recording density, it is required to develop a nonmagnetic under layer capable of obtaining a further improved orientation. Under the circumstances, various studies are being made in an attempt to arrive at new materials of the under layer and the combination of laminations of the under layers in each of the cases where a soft magnetic layer is arranged and not arranged between the under layer and the substrate. However, sufficient magnetic recording characteristics capable of fully coping with the demands for the further improvement of the recording density in the future have not yet been obtained when it comes to the nonmagnetic under layers published to date.

### BRIEF SUMMARY OF THE INVENTION

An object of the present invention, which has been achieved in view of the situation described above, is to provide a magnetic recording medium capable of exhibiting a high coercive force and obtaining a high reproducing output by improving the perpendicular orientation of the Co-based magnetic recording layer.

According to a first aspect of the present invention, there is provided a perpendicular magnetic recording medium, comprising a nonmagnetic substrate, a first under layer formed on the nonmagnetic substrate and containing iron, a second under layer formed on the first under layer and containing mainly ruthenium, and a magnetic recording layer formed on the second under layer and containing mainly cobalt.

According to a second aspect of the present invention, there is provided a perpendicular magnetic recording medium, comprising a nonmagnetic substrate, a first under layer formed on the nonmagnetic substrate and containing cobalt, a second under layer formed on the first under layer and containing mainly ruthenium, and a magnetic recording layer formed on the second under layer and containing mainly cobalt.

According to a third aspect of the present invention, there is provided a perpendicular magnetic recording medium, comprising a nonmagnetic substrate, a first under layer formed on the nonmagnetic substrate and containing mainly ruthenium, a second under layer formed on the first under layer and containing mainly cobalt, and a magnetic recording layer formed on the second under layer and containing mainly cobalt.

According to a fourth aspect of the present invention, there is provided a perpendicular magnetic recording medium, comprising a nonmagnetic substrate, a first under layer formed on the nonmagnetic substrate and containing titanium, a second under layer formed on the first under layer and containing mainly ruthenium, and a magnetic recording layer formed on the second under layer and containing mainly cobalt.

According to a fifth aspect of the present invention, there is provided a perpendicular magnetic recording medium, comprising a nonmagnetic substrate, a soft magnetic layer formed on the nonmagnetic substrate, a first under layer formed on the soft magnetic layer and containing as a main component at least one of vanadium and chromium, a second under layer formed on the first under layer and containing mainly ruthenium, and a magnetic recording layer formed on the second under layer and containing mainly cobalt.

According to a sixth aspect of the present invention, there is provided a perpendicular magnetic recording medium, comprising a nonmagnetic substrate, and a magnetic recording layer formed on the nonmagnetic substrate and having a multi-layered structure prepared by alternately laminating a ferromagnetic layer containing mainly cobalt and a nonmagnetic layer containing mainly ruthenium.

According to the present invention, a perpendicular magnetic recording medium having a high coercive force and a high reproducing output can be obtained by disposing a nonmagnetic layer containing mainly ruthenium somewhere in the perpendicular magnetic recording medium. Such a non magnetic layer containing mainly ruthenium can be formed as a first under layer, and a layer containing another suitable element is formed as a second under layer. Alternatively, a layer containing another suitable element is formed as a first under layer, and such a nonmagnetic layer containing mainly ruthenium is formed as a second under layer in the perpendicular magnetic recording medium of the present invention. Further, it is also possible to form a multi-layered magnetic recording layer by alternately laminating a Co-based magnetic layer and such Ru-based nonmagnetic layer so as to enable the perpendicular magnetic recording medium of the present invention to exhibit a high coercive force and a high reproducing output.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 schematically shows the construction of an example of a magnetic recording medium of the present invention;

FIG. 2 schematically shows the construction of another example of a magnetic recording medium of the present invention;

FIG. 3 schematically shows the construction of still another example of a magnetic recording medium of the present invention; and

FIG. 4 is a view showing the construction of an example of the magnetic recording apparatus in which the magnetic recording medium of the present invention can be applied.

### DETAILED DESCRIPTION OF THE INVENTION

The perpendicular magnetic recording medium of the present invention comprises a nonmagnetic substrate and a Co-based perpendicular magnetic recording layer, and the present invention can be roughly classified into some types on the basis of the five view points described below.

In the perpendicular magnetic recording medium according to the first to fourth view points of the present invention, a first underlying and a second under layer are formed in the order mentioned between the nonmagnetic substrate and a Co-based perpendicular magnetic recording layer. Any one of the first, second under layers, contains ruthenium. The perpendicular magnetic recording medium according to the first to fourth view points of the present invention is characterized as follows by the laminate structure consisting of a nonmagnetic layer containing ruthenium, a layer containing another element, and a Co-based perpendicular magnetic recording layer.

The first type of the present invention provides a perpendicular magnetic recording medium, comprising a nonmagnetic substrate, a first under layer formed on the nonmagnetic substrate and containing iron, a second under layer formed on the first under layer and containing mainly ruthenium, and a magnetic recording layer formed on the second under layer and containing mainly cobalt.

According to a preferred embodiment of the first type of the present invention, the first under layer consists essentially of iron. Alternatively, the first under layer contains iron as a main component and at least one element selected from the group consisting of aluminum, silicon, tantalum, carbon, zirconium, nitrogen and cobalt as an auxiliary component.

According to the first type of the present invention, it is possible to improve the perpendicular orienting properties and magnetic characteristics of a perpendicular magnetic recording medium having a Co-based, such as a CoPtO-based alloy by using an under layer of a laminate structure comprising a first under layer consisting essentially of iron or containing iron as a main component and, preferably, a body-centered cubic crystal material described above, as an auxiliary component, and a second under layer containing ruthenium of a hexagonal close-packed structure. This construction is effective for ensuring a fineness and an uniformity of a crystal diameter in addition to an improvement of a crystal orientation in regard to the second under layer, therefore a fineness and an uniformity of a crystal diameter is promoted in addition to an improvement of a perpendicular crystal orientation in regard to the Co-based magnetic recording layer so as to decrease a transition noise and improve a recording resolution of the recording medium.

Preferred combinations of the main component and the auxiliary component include the combination of iron, tantalum and carbon, the combination of iron, zirconium and nitrogen, the combination of iron and cobalt, and the combination iron, aluminum and silicon. The iron alloy containing not higher than 10 atomic % of at least one of aluminum and silicon is called, for example, Sendust.

These preferred combinations are soft magnetic alloys having a high magnetic permeability.

Conventional Sendust, which is an iron alloy containing 5% of aluminum, 10% of silicon and the remaining part 85% of iron, has a basic crystal structure equal to that of iron. A soft magnetic material having a high permeability can be obtained by adding Al and Si to an iron alloy. Even if the characteristics as a soft magnetic material are changed by the change of the addition amount within a range within which the basic crystal structure is not changed, the resultant medium can be expected to produce the similar effect.

In the second type of the present invention, the first under layer contains cobalt as a main component, and the second under layer contains ruthenium as a main component.

According to the second type of the present invention, the under layer is formed of a material of a hexagonal close-packed structure or an amorphous material containing cobalt as a main component. Also, the second under layer, which is laminated on the first under layer, is formed of ruthenium of a hexagonal close-packed structure. The particular construction of the under layers permits improving the perpendicular orienting properties and the magnetic properties of the perpendicular magnetic recording medium comprising a Co-based magnetic layer, particularly, a CoPtO-based magnetic layer. This construction is effective for ensuring a fineness and an uniformity of a crystal diameter in addition to an improvement of a crystal orientation in regard to the second under layer, therefore a fineness and an uniformity of a crystal diameter is promoted in addition to an improvement of a perpendicular crystal orientation in regard to the Co-based magnetic recording layer so as to decrease a transition noise and improve a recording resolution of the recording medium.

In the preferred embodiment of the second type of the present invention, it is desirable for the first under layer to contain at least one auxiliary component selected from the group consisting of zirconium, niobium and chromium. Also, the preferred combinations of the main component and the auxiliary component includes a combination of cobalt, zirconium and niobium and a combination of cobalt and chromium. It is desirable for the alloy containing cobalt and chromium not to exhibit ferromagnetism. Also, the combination of cobalt, zirconium and niobium forms a soft magnetic alloy having a high magnetic permeability.

It is possible to use a soft magnetic alloy having a high permeability such as a CoZr-based alloy like CoZrNb, an FeCo-based alloy, an FeSi-based alloy, an FeTaC, FeZrN and NiFe-based alloy like Permalloy for forming a soft magnetic layer that is interposed between the nonmagnetic substrate and the perpendicular magnetic recording layer like the first under layer used in each of the first and second types of the present invention.

The perpendicular magnetic recording medium using the particular soft magnetic material having a high magnetic permeability, which performs the function of a so-called “double layered perpendicular medium”, performs a part of the function of the magnetic head that the recording magnetic field from the magnetic head is refluxed and is expected to produce excellent recording/reading characteristics interaction. Even in the case of using such a soft magnetic layer, the perpendicular orienting effect is considered to be substantially the same by applying an under layer of a laminate structure to the perpendicular magnetic recording layer.

In the third type of the present invention, the first under layer contains ruthenium as a main component, and the second under layer contains cobalt as a main component.

In the third type of the present invention, it is desirable for the second under layer to contain chromium as an auxiliary component. In this case, it is desirable for the cobalt-chromium alloy not to exhibit ferromagnetism.

Also, it is desirable for the first under layer to consist essentially of ruthenium.

According to the third type of the present invention, the first under layer is formed of a material containing ruthenium of a hexagonal close-packed structure as a main component. Also, the second under layer, which is laminated on the first under layer, is formed of a material of a hexagonal close-packed structure containing cobalt as a main component. The particular construction makes it possible to improve the perpendicular orienting properties and the magnetic properties of the perpendicular magnetic recording medium comprising a Co-based magnetic layer, particularly, a CoPtO-based magnetic layer. This construction is effective for ensuring a fineness and an uniformity of a crystal diameter in addition to an improvement of a crystal orientation in regard to the second under layer, therefore a fineness and an uniformity of a crystal diameter is promoted in addition to an improvement of a perpendicular crystal orientation in regard to the Co-based magnetic recording layer so as to decrease a transition noise and improve a recording resolution of the recording medium.

According to the fourth type of the present invention, employed is a laminate structure formed on the substrate and comprising a first under layer containing titanium as a main component, a second under layer containing ruthenium as a main component and a perpendicular magnetic recording layer containing cobalt.

The nonmagnetic layer containing titanium, which is a material of a hexagonal close-packed structure and used as a first under layer, is formed of, for example, titanium or a compound selected from the group consisting of a nitride, a carbide and an oxide of titanium. It is also possible to use a titanium chromium alloy.

It is possible to form, for example, TiN having a NaCl structure by the sputtering of a TiN target under an argon gas atmosphere. Titanium and nitrogen are not necessarily bonded to each other at a ratio of 1:1 on the substrate, and it is considered that a nitride having a partially different ratio is formed. Further, substantially the same effect can be obtained in the case of forming an under layer formed of titanium alone. The similar effect on an improvement of a perpendicular orientation can be obtained in the cases where the under layer is formed of not only TiN but also a nitride having a different ratio and where a nitride and titanium are present together in the under layer. Further, the similar effect can be expected in respect of the carbide and oxide of titanium.

The chromium addition amount in TiCr suitable for the first under layer is not higher than 10 atomic %. Since titanium and chromium do not form a solid solution under room temperature, the basic crystal structure is similar to that of Ti and, thus, the similar effect can be obtained sufficiently.

A layer containing ruthenium is used as the second under layer.

According to the present invention, a first under layer consisting of a specified nonmagnetic or soft magnetic material, a second under layer consisting of a specified nonmagnetic material, and a layer consisting of a ferromagnetic Co-based alloy material are formed on the substrate, thereby making the Co-based alloy layer, particularly, a CoPtO ferromagnetic layer having an excellent perpendicular orientation. As a result, it is possible to obtain a magnetic recording medium exhibiting a high coercive force and a high reproducing output.

Also, according to the present invention, it is possible to arrange a soft magnetic layer between the perpendicular magnetic recording medium relating to the first to fourth view points and the first under layer.

It should be noted in respect of the effects produced by the soft magnetic layer that the presence of the soft magnetic layer permits the resultant magnetic recording medium to perform the function of a perpendicular double layered medium and that the magnetic recording layer is enabled to produce excellent recording-reproducing characteristics by the interactive between the head and the soft magnetic layer.

Examples of the materials forming the soft magnetic layer include Sendust, Permalloy, ferrite, FeGaGe, FeGeSi, FeAlGa, FeRuGaSi, FeSi, FeCoNi, FeSiB, FeNiPb, FeSiC, FeCuNbSiB, FeZrB, FeZrBCu, CoFeSiB, CoZrTa, and CoTi.

According to the fourth type of the present invention, the presence of the soft magnetic layer with the Co-based alloy magnetic recording layer permits the resultant magnetic recording medium to produce the effect of a double layered medium, and it is possible to obtain the Co-based alloy magnetic recording layer, particularly, a CoPtO alloy layer, exhibiting excellent perpendicular orientation. As a result, it is possible to obtain a magnetic recording medium exhibiting a high coercive force and a high reproducing output.

According to the fifth type of the present invention, there is provided a perpendicular magnetic recording medium, comprising a nonmagnetic substrate, a soft magnetic layer formed on the nonmagnetic substrate, a first under layer formed on the soft magnetic layer, a second under layer formed on the first under layer and containing ruthenium, and a magnetic recording layer formed on the second under layer and containing mainly cobalt, wherein the first under layer contains mainly at least one of the vanadium and chromium and is capable of optionally containing iron.

The produced effect and the preferred examples of the soft magnetic layer used are similar to those described previously.

According to the fifth type of the present invention, the presence of the soft magnetic layer with the Co-based alloy magnetic recording layer permits the resultant magnetic recording medium to produce the effect of a double layered medium, and it is possible to obtain the Co-based alloy magnetic recording layer, particularly, a CoPtO alloy layer, exhibiting excellent perpendicular orientation. As a result, it is possible to obtain a magnetic recording medium exhibiting a high coercive force and a high reproducing output.

It is desirable to use vanadium or chromium for forming the first under layer.

In the perpendicular magnetic recording medium according to the first to fifth types of the present invention, the material of the magnetic recording layer is not limited to the CoPtO alloy system. It is also possible for the magnetic recording layer to be formed of a CoCrPt-based alloy, or a multi-layered film system consisting of a Co film and a Pt film, consisting of a Co film and a Pd film or consisting of a Co film and a Ru film. The similar effect can be obtained even in the case where the film also contains oxygen. Also, the film containing ruthenium, which is used in the perpendicular magnetic recording medium according to the first to fifth types of the present invention, consists essentially of ruthenium. However, it is possible to add another element such as Cr or Co to the film containing ruthenium.

According to the first to fifth types of the present invention, an appropriate combination of a layer containing ruthenium and another layer containing another element is used as the first and second under layers, and the particular combination is laminated below the perpendicular magnetic recording layer. As a result, the crystal orientation of the second under layer is improved by the first under layer. In addition, the crystal grains are made finer and uniform in the second under layer. Also, since the perpendicular magnetic recording layer is formed on the second under layer, the perpendicular orientation of the recording layer is improved by the presence of the second under layer. In addition, the crystal grains are microcrystallized and made uniform in the perpendicular magnetic recording layer. It follows that it is possible to suppress the transition noise of the recording medium and to improve the recording resolution of the recording medium.

Further, in order to prevent the under layer formed on the soft magnetic layer from being affected by the crystal orientation and the crystal grain diameter in the soft magnetic layer, it is possible to form an amorphous material layer made of, for example, carbon on the soft magnetic layer.

It is also possible to form an antiferromagnetic layer such as an FeMn layer or an antimagnetic layer such as a CoSm layer between the non magnetic substrate and the soft magnetic layer to form an axis of a soft magnetic layer be uniform in the direction of circumference or radius.

According to the sixth type of the present invention, used is a multi-layered perpendicular magnetic recording layer having a multi-layered structure consisting of a Co-based magnetic layer and a Ru-based nonmagnetic layer that are alternately laminated one upon the other. The recording layer having the particular multi-layered structure permits further improving the perpendicular orientation and the perpendicular coercive force.

Also, according to the present invention, the multi-layered perpendicular magnetic recording layer can be used as the perpendicular magnetic recording layer according to the first to fifth view points of the present invention.

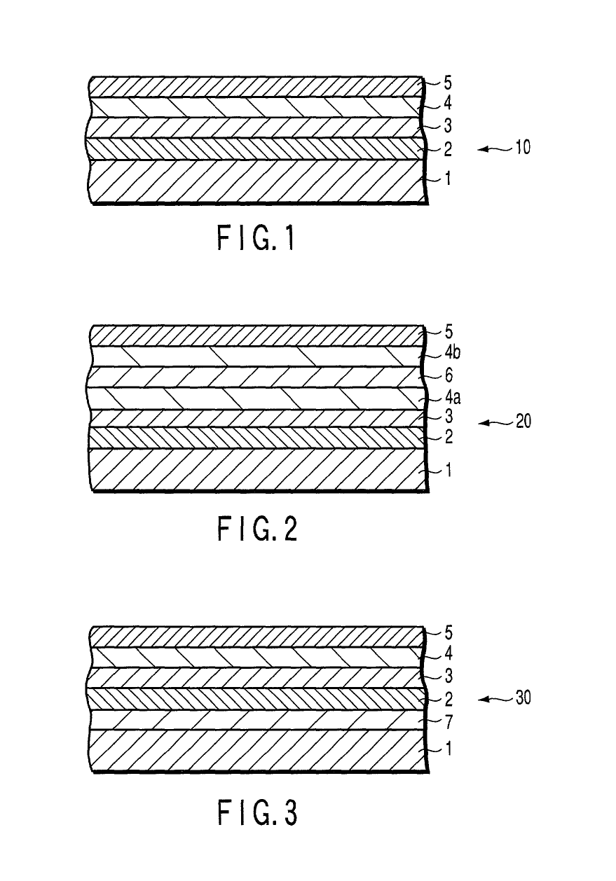

FIG. 1 shows an example of the construction of a magnetic recording medium 10 of the present invention. As shown in the drawing, the magnetic recording medium 10 comprises a substrate 1, a first under layer 2 formed on the substrate 1, a second under layer 3 formed on the first under layer 2, a Co-based ferromagnetic layer 4 made of, for example, a CoPtO alloy and formed on the second under layer 3, and a protective layer 5 formed on the ferromagnetic layer 4.

Each of the layers laminate on the substrate 1 can be formed by a sputtering method with the materials of these layers used as targets.

FIG. 2 shows the construction of another example of a magnetic recording medium of the present invention. As shown in the drawing, the magnetic recording medium 20 shown in FIG. 2 is substantially equal in construction to the magnetic recording medium 10 shown in FIG. 1, except that a laminate structure comprising a magnetic layer 4a, another magnetic layer 4b and a nonmagnetic layer 6 made of ruthenium and interposed between the magnetic layers 4a and 4b is formed in place of the magnetic layer 4 shown in FIG. 1. Preferably, the nonmagnetic layer 6 should consist essentially of ruthenium. Where the magnetic layer is of a multi-layer structure constructed such that a nonmagnetic layer containing ruthenium as a main component, which is a nonmagnetic intermediate layer, is sandwiched between two adjacent ferromagnetic layers, it is possible to further improve the perpendicular orienting properties and the magnetic properties of the magnetic layer.

FIG. 3 is a cross sectional view showing still another example of the construction of a magnetic recording medium 30 of the present invention. As shown in the drawing, the magnetic recording medium 30 shown in FIG. 3 is substantially equal in construction to the magnetic recording medium 10 shown in FIG. 1, except that a soft magnetic layer 7 is interposed between the substrate 1 and the first under layer 2 in the magnetic recording medium 30 shown in FIG. 3. The presence of the soft magnetic layer 7 permits the resultant magnetic recording medium 30 to perform the function of a double layered perpendicular film, and the magnetic recording medium 30 is expected to produce excellent recording/reading characteristics because of the interact between the head and the soft magnetic layer.

The present invention will now be described more in detail with reference the Examples which follow.

### EXAMPLE 1

A glass substrate meeting the standard specification of a 2.5 inch magnetic disc was prepared as a nonmagnetic substrate. Each of the under layers, the magnetic layer, etc. was formed as described below on the glass substrate by means of DC magnetron sputtering.

In the first step, a iron layer was formed on the glass substrate as a first under layer in a thickness of about 50 nm. Then, a ruthenium layer was formed as a second under layer on the iron layer in a thickness of about 37 nm.

In the next step, a CoPtCrO magnetic layer was formed on the second under layer by means of a sputtering of a CoPtCr alloy target under an argon atmosphere containing traces Of O₂. Incidentally, the CoPtCr alloy target contained 20 atomic % of Pt, 16 atomic % of Cr and the balance of Co. In this case, used was a CoPtCr target having a relatively high Cr concentration. However, if the Cr concentration is not higher than 16 atomic %, an essential change in the construction of the magnetic layer is scarcely brought about by the Cr addition, making it possible to obtain the similar effect as the characteristics of the medium.

Finally, a carbon layer having 10 nm of thickness was laminated as a protective layer on the magnetic layer so as to obtain a desired magnetic recording medium.

The magnetic characteristics of the resultant magnetic recording medium were measured by a vibrating sample type magnetometer (VSM), with the results as shown in Table 1. The mark “Hc⊥” in Table 1 represents a coercive force in the case where a magnetic field is applied in a direction perpendicular to the film surface. Also, the mark “Hc//” in Table 1 represents a coercive force in the case where a magnetic field is applied to in a areal direction of the film surface. Further, the perpendicular squareness ratio represents a ratio of the residual magnetization to the saturated magnetization in the case of applying a magnetic field in a perpendicular direction.

### EXAMPLE 2

A magnetic recording medium was prepared as in Example 1, except that a FeTaC layer having a thickness of about 100 nm was formed in place of the Fe layer. The FeTaC layer was formed by sputtering a FeTaC target containing 10 atomic % of Ta, 10 atomic % of C and the balance of Fe under an argon atmosphere. The magnetic properties of the magnetic recording medium thus obtained were measured as in Example 1, with the results as shown in Table 1.

### EXAMPLE 3

A magnetic recording medium was prepared as in Example 1, except that a FezrN layer having a thickness of about 100 nm was formed in place of the Fe layer. The FeZrN layer was formed by sputtering a FeZrN target containing 10 atomic % of Zr, 10 atomic % of N and the balance of Fe under an argon atmosphere. The magnetic properties of the magnetic recording medium thus obtained were measured as in Example 1, with the results as shown in Table 1.

### EXAMPLE 4

A magnetic recording medium was prepared as in Example 1, except that a FeCo layer having a thickness of about 50 nm was formed in place of the Fe layer. The FeCo layer was formed by sputtering a FeCo target containing 50 atomic % of Fe and the balance of Co under an argon atmosphere. The magnetic properties of the magnetic recording medium thus obtained were measured as in Example 1, with the results as shown in Table 1.

### EXAMPLE 5

A magnetic recording medium was prepared as in Example 1, except that a CoZrNb layer having a thickness of about 100 nm was formed in place of the Fe layer. The CoZrNb layer was formed by sputtering a CoZrNb target containing 5 atomic % of Zr, 10 atomic % of Nb and the balance of Co under an argon atmosphere. The magnetic properties of the magnetic recording medium thus obtained were measured as in Example 1, with the results as shown in Table 1.

### EXAMPLE 6

A magnetic recording medium was prepared as in Example 1, except that a Co layer having a thickness of about 75 nm was formed in place of the Fe layer. The magnetic properties of the magnetic recording medium thus obtained were measured as in Example 1, with the results as shown in Table 1.

### EXAMPLE 7

A magnetic recording medium was prepared as in Example 1, except that a CoCr layer having a thickness of about 40 nm was formed in place of the Fe layer. The CoCr layer was formed by sputtering a CoCr target containing 33 atomic % of Cr and the balance of Co under an argon atmosphere. The magnetic properties of the magnetic recording medium thus obtained were measured as in Example 1, with the results as shown in Table 1.

### EXAMPLE 8

A magnetic recording medium was prepared as in Example 1, except that a ruthenium layer having a thickness of about 20 nm was formed as the first under layer in place of the Fe layer, and a CoCr layer having a thickness of about 15 nm was formed as the second under layer in place of the ruthenium layer. The CoCr layer was formed by sputtering a CoCr target containing 33 atomic % of Cr and the balance of Co under an argon atmosphere. The magnetic properties of the magnetic recording medium thus obtained were measured as in Example 1, with the results as shown in Table 1.

### COMPARATIVE EXAMPLE 1

A magnetic recording medium was prepared as in Example 1, except that a Cr layer having a thickness of about 40 nm was formed in place of the Fe layer, and the second under layer was not formed. The magnetic properties of the magnetic recording medium thus obtained were measured as in Example 1, with the results as shown in Table 1.

### COMPARATIVE EXAMPLE 2

A magnetic recording medium was prepared as in Example 1, except that the second under layer was not formed. The magnetic properties of the magnetic recording medium thus obtained were measured as in Example 1, with the results as shown in Table 1.

### COMPARATIVE EXAMPLE 3

A magnetic recording medium was prepared as in Example 2, except that the second under layer was not formed. The magnetic properties of the magnetic recording medium thus obtained were measured as in Example 1, with the results as shown in Table 1.

### COMPARATIVE EXAMPLE 4

A magnetic recording medium was prepared as in Example 3, except that the second under layer was not formed. The magnetic properties of the magnetic recording medium thus obtained were measured as in Example 1, with the results as shown in Table 1.

### COMPARATIVE EXAMPLE 5

A magnetic recording medium was prepared as in Example 4, except that the second under layer was not formed. The magnetic properties of the magnetic recording medium thus obtained were measured as in Example 1, with the results as shown in Table 1.

### COMPARATIVE EXAMPLE 6

A magnetic recording medium was prepared as in Example 5, except that the second under layer was not formed. The magnetic properties of the magnetic recording medium thus obtained were measured as in Example 1, with the results as shown in Table 1.

### COMPARATIVE EXAMPLE 7

A magnetic recording medium was prepared as in Example 6, except that the second under layer was not formed. The magnetic properties of the magnetic recording medium thus obtained were measured as in Example 1, with the results as shown in Table 1.

### COMPARATIVE EXAMPLE 8

A magnetic recording medium was prepared as in Example 7, except that the second under layer was not formed. The magnetic properties of the magnetic recording medium thus obtained were measured as in Example 1, with the results as shown in Table 1.

### COMPARATIVE EXAMPLE 9

A magnetic recording medium was prepared as in Example 8, except that the second under layer was not formed. The magnetic properties of the magnetic recording medium thus obtained were measured as in Example 1, with the results as shown in Table 1.

Where the magnetic recording medium including a soft magnetic layer in addition to the recording magnetic layer is measured by VSM, the resultant characteristics includes both of two characteristics relating to the soft magnetic layer and the magnetic recording layer. However since it is possible to interpret the characteristics separately in respect of Examples 1 to 6, the values for the recording layer approximately alone are shown.

TABLE 1

| | Underlying | | | | Perpendicular |
|---|---|---|---|---|---|
| | layer | Hc⊥(A/m) | Hc//(A/m) | Hc⊥/Hc// | squareness ratio |
| Example 1 | Fe/Ru | 222780 | 103490 | 2.15 | 0.97 |
| Example 2 | FeTaC/Ru | 244110 | 106650 | 2.29 | 0.99 |
| Example 3 | FeZrN/Ru | 240160 | 105860 | 2.27 | 0.98 |
| Example 4 | FeCo/Ru | 249640 | 108230 | 2.31 | 1.00 |
| Example 5 | CoZrNb/Ru | 209350 | 115340 | 1.82 | 0.97 |
| Example 6 | Co/Ru | 263070 | 96380 | 2.73 | 1.00 |
| Example 7 | CoCr/Ru | 271760 | 97960 | 2.77 | 0.99 |
| Example 8 | Ru/CoCr | 269390 | 94800 | 2.84 | 0.98 |
| Comparative Example 1 | Cr | 83740 | 229100 | 0.37 | 0.15 |
| Comparative Example 2 | Fe | 27650 | 18960 | 1.32 | 0.02 |
| Comparative Example 3 | FeTaC | 15010 | 15800 | 0.95 | 0.01 |
| Comparative Example 4 | FeZrN | 14220 | 12640 | 1.13 | 0.01 |
| Comparative Example 5 | FeCo | 16590 | 13430 | 1.24 | 0.02 |
| Comparative Example 6 | CoZrNb | 13430 | 15800 | 0.85 | 0.01 |
| Comparative Example 7 | Co | 33970 | 25280 | 1.34 | 0.05 |
| Comparative Example 8 | CoCr | 180120 | 117710 | 1.53 | 0.99 |
| Comparative Example 9 | Ru | 199080 | 131930 | 1.51 | 0.85 |

A perpendicular orientation is improved with increase in the ratio Hc⊥/Hc// shown in Table 1, and an read output is increased in the case where the perpendicular squareness ratio shown in Table 1 is as close to 1 as possible so as to provide an excellent perpendicular magnetic recording medium. In each of Comparative Example 1, the ratio Hc⊥/Hc// was smaller than 1, and the perpendicular squareness ratio was small, indicating that a areal orientation was formed in each of these Comparative Examples. Also, in each of Comparative Examples 2 to 7, the Hc⊥, Hc// and perpendicular squareness ratio were more smaller the media have approximately complete areal orientation. This is because the soft magnetic layer is not partitioned magnetically with the recording layer so that the properties of the soft magnetic layer having high magnetic moment is predominant. However the properties of the recording layer was not influenced to the whole properties, therefore it is found that the perpendicular orientation of the recording layer is week, and the areal orientation thereof is strong. Comparative Examples 8 and 9, which were not sufficient in terms of the perpendicular orientation, exhibited the most satisfactory characteristics among the Comparative Examples.

On the other hand, any of the Hc⊥/Hc// ratio and the perpendicular squareness ratio in any of Examples 1 to 9 of the present invention was found to be higher than that for any of Comparative Examples 8 and 9. In addition, the squareness ratio was substantially 1 in any of the Examples of the present invention. These clearly support that the characteristics of the perpendicular magnetic recording medium are markedly improved in the present invention. The experimental data clearly support that, an under layer, which fails to exhibit a sufficient perpendicular orientation when used singly, produces the effect of improving the crystallinity of ruthenium when the under layer is used in combination with another under layer containing ruthenium as a main component. In this fashion, the present invention permits obtaining a Co-based magnetic layer exhibiting excellent perpendicular orienting properties, making it possible to obtain a perpendicular magnetic recording medium exhibiting satisfactory characteristics including a high coercive force and a high read output.

### EXAMPLE 9

A magnetic recording medium was obtained as in Example 1, except that a Ti layer having a thickness of about 40 nm was formed as the first under layer in place of the Fe layer. The magnetic characteristics of the magnetic recording medium thus obtained were measured as in Example 1. Table 2 shows the results.

### EXAMPLE 10

A magnetic recording medium was obtained as in Example 1, except that a TiCr layer having a thickness of about 40 nm was formed as the first under layer in place of the Fe layer. The TiCr layer was formed by the sputtering of a target having a composition of Ti—Cr (10 at %) under an Ar gas atmosphere. The magnetic characteristics of the magnetic recording medium thus obtained were measured as in Example 1. Table 2 shows the results.

### EXAMPLE 11

A magnetic recording medium was obtained as in Example 1, except that a TiN layer having a thickness of about 35 nm was formed as the first under layer in place of the Fe layer. The TiN layer was formed by the sputtering of a target having a composition of Ti-N 50 at % under an Ar gas atmosphere. The magnetic characteristics of the magnetic recording medium thus obtained were measured as in Example 1. Table 2 shows the results.

### EXAMPLE 12

A magnetic recording medium was obtained as in Example 1, except that a Sendust layer having a thickness of about 30 nm was formed as the first under layer in place of the Fe layer. The Sendust layer was formed by the sputtering of a target having a composition of Fe 85 at %-Al 5 at %-Si 10 at % under an Ar gas atmosphere. The magnetic characteristics of the magnetic recording medium thus obtained were measured as in Example 1. Table 2 shows the results.

### COMPARATIVE EXAMPLE 10

A magnetic recording medium was obtained as in Example 9, except that a second under layer was not formed. The magnetic characteristics of the magnetic recording medium thus obtained were measured as in Example 1. Table 2 shows the results.

### COMPARATIVE EXAMPLE 11

A magnetic recording medium was obtained as in Example 10, except that a second under layer was not formed. The magnetic characteristics of the magnetic recording medium thus obtained were measured as in Example 1. Table 2 shows the results.

### COMPARATIVE EXAMPLE 12

A magnetic recording medium was obtained as in Example 11, except that a second under layer was not formed. The magnetic characteristics of the magnetic recording medium thus obtained were measured as in Example 1. Table 2 shows the results.

### COMPARATIVE EXAMPLE 13

A magnetic recording medium was obtained as in Example 1, except that a vanadium layer having a thickness of 41 nm was formed as the first under layer in place the Fe layer, and that a second under layer was not formed. The magnetic characteristics of the magnetic recording medium thus obtained were measured as in Example 1. Table 2 shows the results.

### COMPARATIVE EXAMPLE 14

A magnetic recording medium was obtained as in Example 12, except that a second under layer was not formed. The magnetic characteristics of the magnetic recording medium thus obtained were measured as in Example 1. Table 2 shows the results.

TABLE 2

| | Under | | | | Perpendicular |
|---|---|---|---|---|---|
| | layer | Hc⊥(A/m) | Hc//(A/m) | Hc⊥/Hc// | squareness ratio |
| Example 9 | Ti/Ru | 270970 | 93220 | 2.91 | 0.99 |
| Example 10 | TiCr/Ru | 282030 | 99540 | 2.83 | 1.0 |
| Example 11 | TiN/Ru | 273340 | 96380 | 2.84 | 0.98 |
| Example 12 | Sendust/Ru | 203820 | 112970 | 1.80 | 0.96 |
| Comparative Example 10 | Ti | 200660 | 166690 | 1.20 | 0.73 |
| Comparative Example 11 | TiCr | 186440 | 165110 | 1.13 | 0.62 |
| Comparative Example 12 | TiN | 86110 | 145360 | 0.59 | 0.18 |
| Comparative Example 13 | V | 90850 | 226730 | 0.40 | 0.14 |
| Comparative Example 14 | Sendust | 18170 | 15010 | 1.21 | 0.01 |

Where the magnetic recording medium including a soft magnetic layer in addition to the recording magnetic layer is measured by VSM, the resultant characteristics includes both of two characteristics relating to the soft magnetic layer and the magnetic recording layer. However since it is possible to interpret the characteristics separately in respect of Example 12, the values for the recording layer approximately alone are shown.

As apparent from Table 2, the value of Hc⊥/HC// for each of Comparative Examples 12 and 13 was not larger than 1, and the perpendicular squareness ratio was also small, supporting that a areal orientation was formed in each of these Comparative Examples. Also, in Comparative Example 14, the Hc⊥, Hc// and perpendicular squareness ratio were more smaller the media have approximately complete areal orientation. This is because the soft magnetic layer is not partitioned magnetically with the recording layer so that the properties of the soft magnetic layer having high magnetic moment is predominant. However the properties of the recording layer was not influenced to the whole properties, therefore it is found that the perpendicular orientation of the recording layer is week, and the areal orientation thereof is strong. A areal orientation was not recognized in each of Comparative Examples 10 and 11. However, the value of Hc// was large, i.e., not smaller than 2 kOe, and the perpendicular squareness ratio was 0.6 to 0.7 in each of these Comparative Examples, supporting that the perpendicular orientation was insufficient.

As described above, both of Examples 8 and 9 of the present invention exhibited the values of Hc⊥/Hc// and the perpendicular squareness ratio larger than those for Comparative Example 15, and the squareness ratio was substantially 1 in each of Examples 9-12 of the present invention. These clearly support that the characteristics as the perpendicular magnetic recording medium were markedly improved in the present invention. This indicates that, where an under layer is formed under a Ru layer, it is possible to improve the crystallinity of Ru, though when such an under layer is singly formed under the magnetic recording layer, the perpendicular orientation of the magnetic recording layer is insufficient. Such being the situation, it has been clarified that it is possible to obtain a CoPtO-based magnetic layer exhibiting an excellent perpendicular orientation in the case where an under layer of a laminate structure is used as an under layer of the CoPtO-series magnetic layer, said laminate structure consisting of a first under layer made of Ti, TiCr, TiN, V or Sendust and formed on the substrate and a second under layer formed on the first under layer and made of Ru. As a result, it is possible to obtain a perpendicular magnetic recording medium having a high coercive force and exhibiting a high reproducing output.

In each of the Examples described above, a glass substrate was used as the nonmagnetic substrate. However, the similar effect can be obtained in the case where an Al-based alloy substrate, a Si single crystal substrate having an oxidized surface, or a substrate having, for example, NiP plated on the surface is used as the nonmagnetic substrate. Also, the film formation was performed by a sputtering method in each of the Examples described above. However, it is also possible to employ other film formation methods such as a vacuum vapor deposition method, with substantially the same effect.

### EXAMPLE 13

A magnetic recording medium was obtained as in Example 1, except that a FeAlSi soft magnetic layer was formed on a substrate by sputtering a target having a composition of Fe-5 at %-Al 10 at %-Si under an Ar gas atmosphere, and that a V layer having a thickness of 41 nm was formed as the first under layer in place of the Fe layer. The magnetic characteristics of the magnetic recording medium thus obtained were measured as in Example 1. The other magnetic recording media were obtained and the magnetic characteristics of them were measured as the same way except that the compositions were Fe 10 at %-Ta 10 at %-C, Fe 10 at %-Zr 10 at %-N, Fe 50 at %-Co, and Co 5 at % Zr 10 at %-Nb, respectively. It has been found that the magnetic recording media thus obtained were satisfactory in each of the ratio of the perpendicular coercive force to the areal coercive force and the perpendicular squareness ratio.

### EXAMPLE 14

A magnetic recording medium was obtained as in Example 1, except that a Cr layer having a thickness of about 40 nm was formed as the first under layer in place of the Fe layer. The magnetic characteristics of the magnetic recording medium thus obtained were measured as in Example 1. It has been found that the magnetic recording medium thus obtained was satisfactory in each of the ratio of the perpendicular coercive force to the areal coercive force and the perpendicular squareness ratio.

Additional experiments were conducted in line with Examples 1 to 14, except that alloy layers of RuCr and RuCo were used in place of the Ru under layer, with substantially the same improving effects.

Further, additional experiments were conducted by using each of alloy layers of CoPt, CoCr and CoCrPt as the magnetic recording layer in place of the CoPtO recording layer, with substantially the same improving effects.

Still further, additional experiments were conducted by using as a magnetic recording layer a multi-layered film of Co/Pd, Co/Pt or Co/Ru in place of the CoPtO recording layer, said multi-layered film being prepared by alternately laminating 20 times a Co layer having a thickness of about 0.3 nm and a Pd layer, a Pt layer or a Ru layer each having a thickness of about 1 nm, with substantially the same improving effects.

### EXAMPLE 15

Perpendicular magnetic recording media were prepared as in Examples 1 to 14, except that perpendicular magnetic recording layers of a laminate structure were formed in place of each one CoPtO magnetic layer formed in Examples 1 to 14, said laminate structure being prepared by forming a first layer of a CoPtCrO magnetic layer having a thickness of 13 nm, followed by forming a Ru layer having a thickness of 4 nm as a nonmagnetic intermediate layer of the recording layer and subsequently forming again a second layer of a CoPtCrO magnetic layer. The magnetic characteristics of each of the magnetic recording media thus obtained were measured, with the result that the recording layer of the laminate structure was found to be superior to the recording layer of a single layer structure in each of Hcl and Hc⊥/Hc//. The experimental data clearly support that the perpendicular orientation and the perpendicular coercive force of the perpendicular magnetic recording medium can be improved by employing a perpendicular magnetic recording layer of a laminate structure and by using a Ru layer as a nonmagnetic intermediate layer of the laminate structure.

### EXAMPLE 16

Perpendicular magnetic recording media were prepared as in Examples 1 to 12 and 15, except that a so-called “perpendicular double layered medium” was formed by forming a FeAlSi soft magnetic layer between the nonmagnetic substrate and the first under layer. The magnetic characteristics of each of the resultant perpendicular double layer media were evaluated, and the characteristics of the recording layer alone were evaluated by separating the FeAlSi soft magnetic layer, so as to obtain the results substantially equal to those of Examples 1 to 12 and 15. In other words, the characteristics as the perpendicular magnetic recording medium were found to have been improved, compared with Comparative Examples 1 to 14. Such being the situation, it has been clarified that the effect of the FeAlSi soft magnetic layer of the laminate structure can be maintained even where the FeAlSi layer is formed to form a perpendicular double layer medium, making it possible to improve the perpendicular orientation, the perpendicular coercive force and the reproducing output of the perpendicular magnetic recording medium.

### EXAMPLE 17

Perpendicular magnetic recording media were prepared as in Examples 1 to 12 and 15, except that a so-called “perpendicular double layered medium” was formed by forming a FeTaC soft magnetic layer between the nonmagnetic substrate and the first under layer. The magnetic characteristics of each of the resultant perpendicular double layer media were evaluated, and the characteristics of the recording layer alone were evaluated by separating the FeTaC soft magnetic layer, so as to obtain the results substantially equal to those of Examples 1 to 12 and 15. In other words, the characteristics as the perpendicular magnetic recording medium were found to have been improved, compared with Comparative Examples 1 to 14. Such being the situation, it has been clarified that the effect of the under layer of the laminate structure can be maintained even where the FeTaC layer is formed to form a perpendicular double layer medium, making it possible to improve the perpendicular orientation, the perpendicular coercive force and the reproducing output of the perpendicular magnetic recording medium.

### EXAMPLE 18

Perpendicular magnetic recording media were prepared as in Examples 1 to 12 and 15, except that a so-called “perpendicular double layered medium” was formed by forming a FeZrN soft magnetic layer between the nonmagnetic substrate and the first under layer. The magnetic characteristics of each of the resultant perpendicular double layer media were evaluated, and the characteristics of the recording layer alone were evaluated by separating the FeZrN soft magnetic layer, so as to obtain the results substantially equal to those of Examples 1 to 12 and 15. In other words, the characteristics as the perpendicular magnetic recording medium were found to have been improved, compared with Comparative Examples 1 to 14. Such being the situation, it has been clarified that the effect of the under layer of the laminate structure can be maintained even where the FezrN layer is formed to form a perpendicular double layer medium, making it possible to improve the perpendicular orientation, the perpendicular coercive force and the reproducing output of the perpendicular magnetic recording medium.

### EXAMPLE 19

Perpendicular magnetic recording media were prepared as in Examples 1 to 12 and 15, except that a so-called “perpendicular double layered medium” was formed by forming a FeCo soft magnetic layer between the nonmagnetic substrate and the first under layer. The magnetic characteristics of each of the resultant perpendicular double layer media were evaluated, and the characteristics of the recording layer alone were evaluated by separating the FeCo soft magnetic layer, so as to obtain the results substantially equal to those of Examples 1 to 12 and 15. In other words, the characteristics as the perpendicular magnetic recording medium were found to have been improved, compared with Comparative Examples 1 to 14. Such being the situation, it has been clarified that the effect of the under layer of the laminate structure can be maintained even where the FeCo layer is formed to form a perpendicular double layer medium, making it possible to improve the perpendicular orientation, the perpendicular coercive force and the reproducing output of the perpendicular magnetic recording medium.

### EXAMPLE 20

Perpendicular magnetic recording media were prepared as in Examples 1 to 15, except that a so-called “perpendicular double layer medium” was formed by forming a CoZrNb soft magnetic layer between the nonmagnetic substrate and the first under layer. The magnetic characteristics of each of the resultant perpendicular double layer media were evaluated, and the characteristics of the recording layer alone were evaluated by separating the CoZrNb soft magnetic layer, so as to obtain the results substantially equal to those of Examples 1 to 12 and 15. In other words, the characteristics as the perpendicular magnetic recording medium were found to have been improved, compared with Comparative Examples 1 to 14. Such being the situation, it has been clarified that the effect of the under layer of the laminate structure can be maintained even where the CoZrNb layer is formed to form a perpendicular double layer medium, making it possible to improve the perpendicular orientation, the perpendicular coercive force and the reproducing output of the perpendicular magnetic recording medium.

It should be noted that the materials of the soft magnetic layer are not limited to those used in the Examples of the present invention described above. Particularly, it was found possible to obtain the similar effect by using the other soft magnetic materials in the case of forming an amorphous layer such as a carbon layer on the soft magnetic layer.

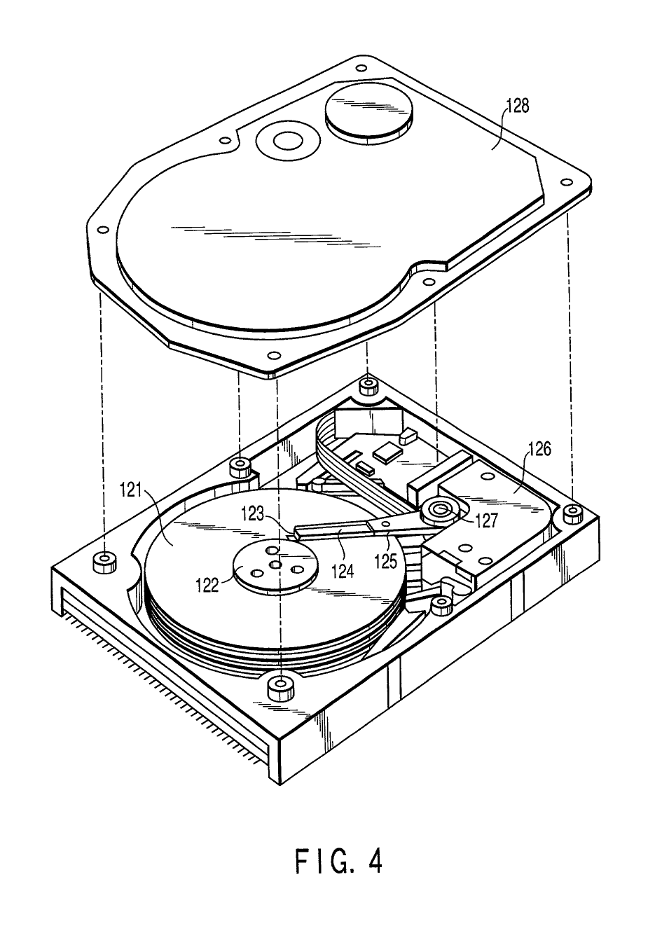

FIG. 4 shows an example of the magnetic recording apparatus in which the perpendicular magnetic recording media according to the first to sixth aspects of the present invention can be applied. As shown in the drawing, a magnetic disc 121 of a hard structure for recording information is mounted to a spindle 122 and is rotated at a predetermined speed by a spindle motor (not shown). A slider 123 has a magnetic head is provided on the tip of a suspension 124 formed in a thin plate-like leaf spring which access to the magnetic disc 121 to read and write signals. The suspension 124 is connected to one end portion of an arm 125 having a bobbin etc. for holding a driving coil (not shown).

A voice coil motor 126, which is a kind of a linear motor, is mounted on the other end portion of the arm 125. The voice coil motor 126 comprises a driving coil (not shown) wound up to the bobbin portion of the arm 125 and a magnetic circuit consisting of a permanent magnet arranged to have the driving coil held therein and a yoke positioned to face the permanent magnet.

The arm 125 is held by ball bearings mounted in the upper and lower portions of a stationary shaft 127 so as to be rotated and swung by the voice coil motor 126. In other words, the position of the slider 123 on the magnetic disc 121 is controlled by the voice coil motor 126. Incidentally, a reference numeral 128 in FIG. 4 denotes a lid.

The perpendicular magnetic recording media according to the first to sixth aspects of the present invention have good perpendicular orientation and perpendicular coercive force in the recording layer thereof. Therefore a hard disk device exhibiting high density and high read output can be realized by using one of such media.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A perpendicular magnetic recording medium comprising:
a nonmagnetic substrate;
a first under layer formed on the nonmagnetic substrate and containing iron as a main component;
a second under layer formed on the first under layer and containing mainly ruthenium; and
a magnetic recording layer formed on the second under layer and containing mainly cobalt.

2. The perpendicular magnetic recording medium according to claim 1, wherein said first under layer further contains an auxiliary component selected from the group consisting of a combination of aluminum and silicon, a combination of tantalum and carbon, a combination of zirconium and nitrogen, and cobalt.

3. The perpendicular magnetic recording medium according to claim 1, wherein said magnetic recording layer further contains at least one of platinum and chromium.

4. The perpendicular magnetic recording medium according to claim 1, wherein said magnetic recording layer further contains platinum and oxygen.

5. The perpendicular magnetic recording medium according to claim 1, wherein said magnetic recording layer has a multi-layered structure prepared by alternately laminating a ferromagnetic layer containing cobalt and a nonmagnetic layer mainly containing one element selected from the group consisting of ruthenium, palladium and platinum.

6. The perpendicular magnetic recording medium according to claim 1, further comprising a soft magnetic layer formed between said nonmagnetic substrate and said first under layer.

7. The perpendicular magnetic recording medium according to claim 6, wherein said soft magnetic layer contains an alloy selected from the group consisting of an iron-aluminum-silicon series alloy, an iron-tantalum-carbon series alloy, an iron-zirconium-nitrogen series alloy, cobalt-zirconium-nitrogen series alloy, and an iron-cobalt series alloy.

8. A perpendicular magnetic recording medium comprising:
a nonmagnetic substrate;
a first under layer formed on the nonmagnetic substrate and containing cobalt;
a second under layer formed on the first under layer and containing mainly ruthenium; and
a magnetic recording layer formed on the second under layer and containing cobalt as a main component.

9. The perpendicular magnetic recording medium according to claim 8, wherein said first under layer further contains at least one auxiliary component is one of a combination of zirconium and niobium and chromium.

10. The perpendicular magnetic recording medium according to claim 8, wherein said first under layer does not exhibit ferromagnetism.

11. The perpendicular magnetic recording medium according to claim 8, wherein said magnetic recording layer further contains at least one of platinum and chromium.

12. The perpendicular magnetic recording medium according to claim 8, wherein said magnetic recording layer further contains platinum and oxygen.

13. The perpendicular magnetic recording medium according to claim 8, wherein said magnetic recording layer has a multi-layered structure prepared by alternately forming a ferromagnetic layer containing cobalt and a nonmagnetic layer containing mainly one of ruthenium, palladium and platinum.

14. The perpendicular magnetic recording medium according to claim 8, further comprising a soft magnetic layer interposed between said nonmagnetic substrate and said first layer.

15. The perpendicular magnetic recording medium according to claim 14, wherein said soft magnetic layer contains an alloy selected from the group consisting of an iron-aluminum-silicon series alloy, an iron-tantalum-carbon series alloy, an iron-zirconium-nitrogen series alloy and an iron-cobalt series alloy.

16. A perpendicular magnetic recording medium comprising:
a nonmagnetic substrate;
a first under layer formed on the nonmagnetic substrate and containing mainly ruthenium;
a second under layer formed on the first under layer and containing mainly cobalt; and
a magnetic recording layer formed on the second under layer and containing mainly cobalt.

17. The perpendicular magnetic recording medium according to claim 16, wherein said second under layer further contains chromium.

18. The perpendicular magnetic recording medium according to claim 17, wherein said second under layer does not exhibit a ferromagnetism.

19. The perpendicular magnetic recording medium according to claim 16, wherein said magnetic recording layer further contains at least one of platinum and chromium.

20. The perpendicular magnetic recording medium according to claim 19, wherein said magnetic recording layer further contains platinum and oxygen.

21. The perpendicular magnetic recording medium according to claim 16, wherein said magnetic recording layer has a multi-layered structure prepared by alternately forming a ferromagnetic layer containing cobalt and a nonmagnetic layer containing mainly one of ruthenium, palladium and platinum.

22. The perpendicular magnetic recording medium according to claim 16, further comprising a soft magnetic layer interposed between said nonmagnetic substrate and said first under layer.

23. The perpendicular magnetic recording medium according to claim 16, wherein said soft magnetic layer contains an alloy selected from the group consisting of an iron-aluminum-silicon series alloy, an iron-tantalum-carbon series alloy, an iron-zirconium-nitrogen series alloy, and an iron-cobalt series alloy.

24. A perpendicular magnetic recording medium comprising;
a nonmagnetic substrate;
a first under layer formed on the nonmagnetic substrate and containing titanium;
a second under layer formed on the first under layer and containing mainly ruthenium; and
a magnetic recording layer formed on the second under layer and containing mainly cobalt.

25. The perpendicular magnetic recording medium according to claim 24, wherein said first under layer is formed of a material selected from the group consisting of a nitride, a carbide and oxide of titanium, a titanium chromium alloy, and a substantially elemental titanium.

26. The perpendicular magnetic recording medium according to claim 25, wherein said first under layer is formed of a material selected from the group consisting of a nitride of titanium a titanium chromium alloy, and a substantially elemental titanium.

27. The perpendicular magnetic recording medium according to claim 24, wherein said magnetic recording layer further contains at least one element selected from the group consisting of platinum and chromium.

28. The perpendicular magnetic recording medium according to claim 24, wherein said magnetic recording layer further contains platinum and oxygen.

29. The perpendicular magnetic recording medium according to claim 24, wherein said magnetic recording layer has a multi-layered structure prepared by alternately forming a ferromagnetic layer containing cobalt and a nonmagnetic layer containing one element selected from the group consisting of ruthenium, palladium and platinum.

30. The perpendicular magnetic recording medium according to claim 24, further comprising a soft magnetic layer interposed between said nonmagnetic substrate and said first under layer.

31. The perpendicular magnetic recording medium according to claim 30, wherein said soft magnetic layer contains an alloy selected from the group consisting of an iron-aluminum-silicon series alloy, an iron-tantalum-carbon series alloy, an iron-zirconium-nitrogen series alloy, a cobalt-zirconium-niobium series alloy, and an iron-cobalt series alloy.

32. A perpendicular magnetic recording medium comprising:
a nonmagnetic substrate;
a soft magnetic layer formed on the nonmagnetic substrate;
a first under layer formed on the soft magnetic layer and containing as a main component at least one of vanadium and chromium;
a second under layer formed on the first under layer and containing mainly ruthenium; and
a magnetic recording layer formed on the second under layer and containing mainly cobalt.

33. The perpendicular magnetic recording medium according to claim 32, wherein said magnetic recording layer further contains at least one of platinum and chromium.

34. The perpendicular magnetic recording medium according to claim 32, wherein said magnetic recording layer further contains platinum and oxygen.

35. The perpendicular magnetic recording medium according to claim 32, wherein said magnetic recording layer has a multi-layered structure prepared by alternately forming a ferromagnetic layer containing cobalt and a nonmagnetic layer containing mainly one of ruthenium, palladium and platinum.

36. The perpendicular magnetic recording medium according to claim 32, wherein said soft magnetic layer contains an alloy selected from the group consisting of an iron-aluminum-silicon series alloy, an iron-tantalum-carbon series alloy, an iron-zirconium-nitrogen series alloy cobalt zirconium-niobium series alloy, and an iron-cobalt series alloy.

37. A perpendicular magnetic recording medium, comprising:
a nonmagnetic substrate; and
a magnetic recording layer formed on the nonmagnetic substrate and having a multi-layered structure prepared by alternately laminating a ferromagnetic layer containing mainly cobalt and a nonmagnetic layer containing mainly ruthenium.

38. The perpendicular magnetic recording medium according to claim 37, wherein said ferromagnetic layer further contains at least one of chromium and a combination of platinum and chromium.

39. The perpendicular magnetic recording medium according to claim 38, wherein said ferromagnetic layer further contains platinum and oxygen.
